(19) United States
(12) Patent Application Publication
(10) Pub. No.: US 2006/0191397 A1
(43) Pub. Date: Aug. 31, 2006

(54) Button of wind instrument

(76) Inventor: Wei-Fu Lin, Fengyuan City (TW)

Correspondence Address: RABIN & BERDO, P.C., Suite 500, 1101 14th Street, N.W., Washington, DC, 20005, US

(21) Appl. No.: 11/065,059

(22) Filed: Feb. 25, 2005

(51) Int. Cl. G10D 7/08; G10D 9/04; G10D 9/00

(52) U.S. Cl. 84/385 R

(57) ABSTRACT

An Improved Button of Wind Instruments is a kind of round button, which can be used for various wind instruments, such as soprano saxophones, alto saxophones, tenor saxophones, baritone saxophones and trumpets etc.; its characteristics contain: a bulge formed taking the center of button as the vertex, and the interface falls slowly from the vertex towards peripheral edge and forms a curved surface seeing from the side; According to the abovementioned structure, it not only would be handled easily, and the adjustment of fingering and the button's height would not be required, but also would be touched easily. And its extended area can increase the control speed and sensitivity.

### BACKGROUND OF THE PRESENT INVENTION

I. Field of the Present Invention

The present invention provides a kind of Improved Button of Wind Instrument, particularly the one that the shape of the function button was improved. It not only would be handled easily, and the adjustment of fingering and the button's height would not be required, but also would be touched easily. And its extended area can increase the control speed and sensitivity.

II. Description of the Prior Art

Usually, the popular wind instruments in the market, such as soprano saxophones, alto saxophones, tenor saxophones, baritone saxophones, trumpets, mainly be controlled by means of touching the button with finger, and the traditional buttons a mostly are the round groove. As shown in FIGS. 1 and 1A, seeing from the side, there is a round groove a1 in the center, which is used for strengthening the control effect of finger and the button. However, factually slippage would still exist while the finger b staying in the groove a1, particularly for the mental buttons, this circumstance would more frequent. Additionally, the button a will make the finger b move with the opening of sound hole. It would be very uncomfortable while the finger b touches the edge of groove a1. Besides, because of different height of each user and their different fingers' length, this design would limit the activity space of the finger. It does not accord with the human physiology.

Therefore, the inventor of the present invention honestly flings himself upon researching and developing a kind of round button, which accords with the human physiology and can be applied to various fingers of different length and controlled easily. There is a convex surface in the central part, which can be touched easily without additional adjustment of fingering and button's height. And its extended area can increase the control speed and sensitivity.

### SUMMARY OF THE INVENTION

Considering the above-mentioned imperfect structure of the prior ones, the inventor of the present invention researches carefully and developed a kind of uptodate Improved Button of Wind Instrument based on his experiences in this course for many years.

The purpose of the present invention is to provide a kind of button for wind instrument, which would be handled easily. Additionally its contact area was increased.

For the purpose above, the present invention mainly aims at round button, in which the center of the interface between button's upper side and finger is the vertex, and the interface falls slowly from the vertex towards peripheral edge. Seeing from the side, the interface is a curved one and forms a convex button in the center.

According to the abovementioned structure, the button's angle may not be adjusted of purpose while touch it, the finger can touch its interface and produce some action force freely from any angle. The problems that caused by the length of different fingers would be reduced. For the prior buttons, we must bend our finger to work in the button's position while using, and our finger should be plunged in the groove and move inconveniently, and the shorter finger only can touch the edge. So the action force cannot be produced effectively, and that would be not conductive to control. Not only can the convex button the present invention provides make the fingers of different length easily touch it, but also has it good touch feeling. Besides, its surface area is larger than the one of plane and groove button. It can bring its best effects into play at the time of control fast and multi-key linkage.

### BRIEF DESCRIPTION OF THE DRAWINGS

FIG. 1 is the three-dimensional diagram of the prior patent

FIG. 1A is cutaway sketch map of the prior patent

FIG. 2 is the three-dimensional diagram of the present invention

FIG. 2A is cutaway sketch map of the present invention

FIGS. 3A, 3B, 3C are the sketch maps of comparison among the present invention, plane button and groove button

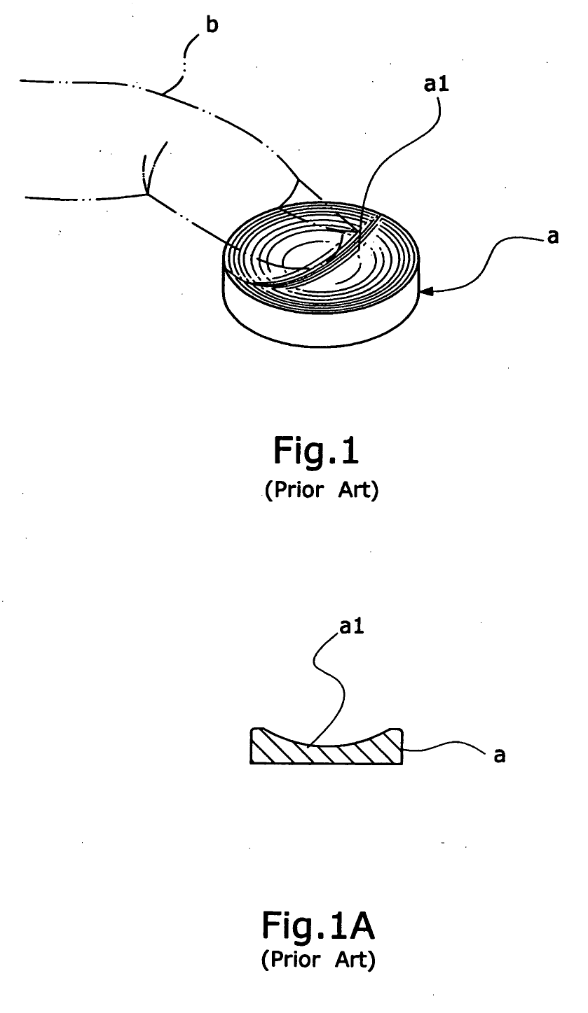

### DESCRIPTION OF THE PREFERRED EMBODIMENT

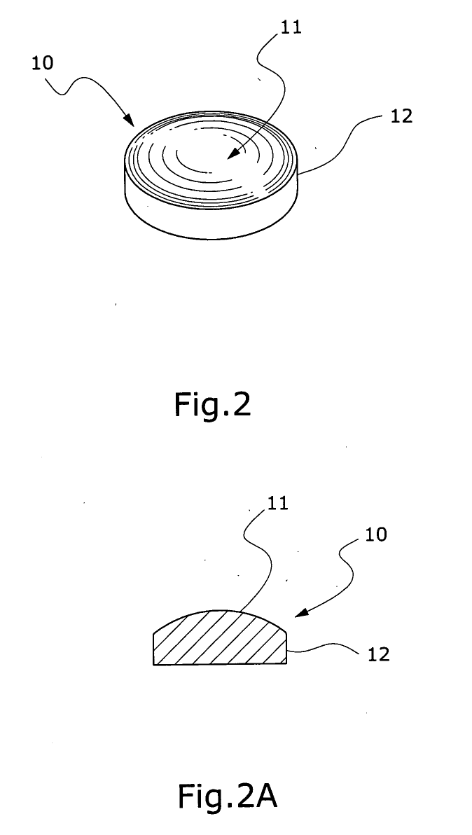

As shown in the FIGS. 2 and 2A, the present invention provides can be used for various wind instruments such as the button 10 of soprano saxophones, alto saxophones, tenor saxophones, baritone saxophones and trumpets, in which the center of the button is the vertex and forms a bulge 11, and the interface falls slowly from the vertex towards peripheral edge 12. Seeing from the side, the interface forms a curved surface.

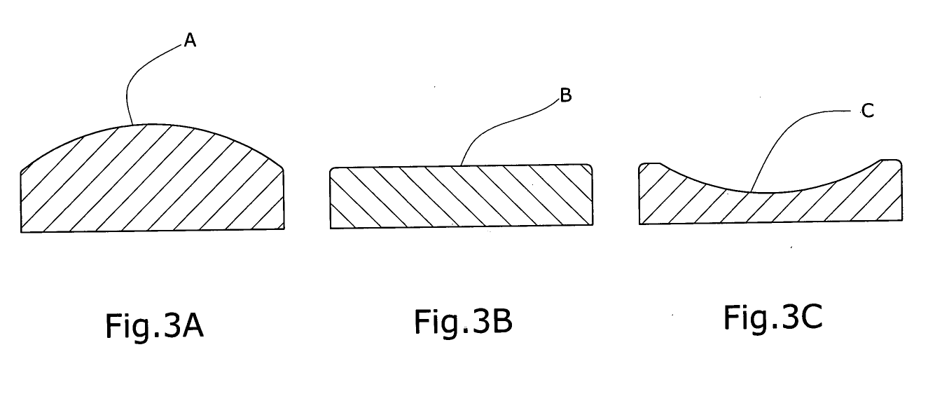

Please refer to the FIGS. 3A, 3B, 3C, which is the sketch map of comparison among the present invention, plane button and groove button, in which A is the curved interface of the present invention, B as the plane interface of the plane button, C as the arc concaved interface of the groove button. And the arc contact area of A is 1.57 times of B, and although the arc interface of A and the concaved one of C are arc, for the edge of the later one, its arc length is shorter than A. Based on the abovementioned contents, the surface area of the convex button is larger than the one of plate and groove button.

While a preferred embodiment of the invention has been shown and described in detail, it will be readily understood and appreciated that numerous omissions, changes and additions may be made without departing from the spirit and scope of the invention.

What is claimed is:

1. An improved button of wind instrument mainly is a kind of round button; its characteristics contain: a bulge formed taking the center of button as the vertex, and the interface falls slowly from the vertex towards peripheral edge and forms a curved surface seeing from the side.

2. The Improved Button of Wind Instrument, as recited in claim 1, wherein said the button can be used for soprano saxophones.

3. The Improved Button of Wind Instrument, as recited in claim 1, wherein said the button can be used for alto saxophones.

4. The Improved Button of Wind Instrument, as recited in claim 1, wherein said the button can be used for tenor saxophones.

5. The Improved Button of Wind Instrument, as recited in claim 1, wherein said the button can be used for baritone saxophones.

6. The Improved Button of Wind Instrument, as recited in claim 1, wherein said the button can be used for trumpets.
